(19) United States
(12) Patent Application Publication
(10) Pub. No.: US 2020/0403458 A1
(43) Pub. Date: Dec. 24, 2020

(54) WIRELESS POWER NETWORK MONITORING METHODS AND DEVICES

(71) Applicant: TRANSFERFI PTE. LTD., Singapore (SG)

(72) Inventors: Mohammad Reza VEDADY MOGHADAM NANEHKARAN, Singapore (SG); Manoj Kumar RAJAKUMAR, Singapore (SG)

(73) Assignee: TRANSFERFI PTE. LTD., Singapore (SG)

(21) Appl. No.: 16/978,664

(22) PCT Filed: Mar. 5, 2019
(86) PCT No.: PCT/SG2019/050123

§ 371 Date: Sep. 4, 2020

(30) Foreign Application Priority Data
Mar. 6, 2018 (SG) 10201801815R

(51) Int. Cl. H02J 50/80; H02J 50/20; H02J 50/40; H02J 7/00; H02J 7/34; H04L 12/24; H04B 1/02; H04B 1/06; G06F 3/0484; G06F 1/28

(52) U.S. Cl. CPC H02J 50/80; H02J 50/20; H02J 50/40; H02J 7/0048; H02J 7/345; H02J 7/00032; H02J 2207/50; H04B 1/02; H04B 1/06; G06F 3/04847; H04L 41/06; G06F 1/28; H04L 41/22

(57) ABSTRACT

Methods of monitoring a wireless power network and wireless power network monitoring devices are disclosed. In an embodiment a wireless power network comprises at least a first wireless power transmitter and at least a first wireless power receiver. A method of monitoring the wireless power network comprises: receiving communication data indicative of an operating state of the first wireless power receiver from the first wireless power transmitter, the communication data being in a data transfer format of the wireless power network; determining operating state information for the first wireless power receiver from the communication data by converting the communication data from the data transfer format of the wireless power network; and displaying the operating state information for the first wireless power receiver in a graphical user interface.

### FIELD

The present disclosure relates to wireless power networks. In particular, the present disclosure relates to methods and devices for monitoring wireless power transmission in wireless power networks.

### BACKGROUND

Wireless power networks allow devices such as sensors to be installed and powered without the requirement for fixed power connections. This provides for flexibility and reduced time for deployment. As the use of such networks grows and the type and specification of devices that are connected to such networks increases, the monitoring and control of the health and performance of the networks becomes an issue.

### SUMMARY OF THE INVENTION

According to a first aspect of the present disclosure a method of monitoring a wireless power network is provided. The wireless power network comprises at least a first wireless power transmitter and at least a first wireless power receiver. The method comprises: receiving communication data indicative of an operating state of the first wireless power receiver from the first wireless power transmitter, the communication data being in a data transfer format of the wireless power network; determining operating state information for the first wireless power receiver from the communication data by converting the communication data from the data transfer format of the wireless power network; and displaying the operating state information for the first wireless power receiver in a graphical user interface.

In an embodiment the method further comprises determining the data transfer format of the wireless power network during a handshaking process.

In an embodiment the method further comprises determining information indicating a type or specification of the first wireless power receiver and customizing the graphical user interface according to the type or specification of the first wireless power transmitter.

In an embodiment the method further comprises storing the operating state information for the first wireless power receiver. In an embodiment the method further comprises encrypting the operating state information for the first wireless power receiver before storing the operating state information.

The operating state of the first wireless power receiver may comprise one or more of the following: instantaneous power consumption of the first wireless power receiver; average power consumption of the first wireless power receiver; a state of charge of an energy storage device of the first wireless power receiver; and/or a received wireless power signal strength at the first wireless power receiver.

According to a second aspect of the present disclosure a method of monitoring a wireless power network is provided. The wireless power network comprises a wireless power transmitter and at least a first wireless power receiver. The method comprises: receiving communication data indicative of an operating state of the first wireless power receiver from the wireless power transmitter, the communication data being in a data transfer format of the wireless power network; determining operating state information for the first wireless power receiver from the communication data by converting the communication data from the data transfer format of the wireless power network; and processing the operating state information for the first wireless power receiver to identify an abnormality; and generating an alert in response to identifying the abnormality.

In an embodiment processing the operating state information to identify an abnormality comprises comparing the operating state information with a threshold or a target range of values. The threshold or the target range of values may be determined from historical operating state information for the first wireless power receiver.

In an embodiment the method further comprises storing the operating state information for the first wireless power receiver as historical operating state information.

In an embodiment the method further comprises generating a control signal for the first wireless power receiver to adjust an operating parameter of the first wireless power receiver. The control signal for the first wireless power receiver may be in the data transfer format of the wireless power network.

In an embodiment the method further comprises displaying an indication of at least one possible corrective action and receiving a user input indicating a corrective action. The user input indicating a corrective action may be a command to adjust an operating parameter of the first wireless power receiver. The control signal for the first wireless power receiver may be in the data transfer format of the wireless power network.

According to a third aspect of the present disclosure a wireless power network monitoring device for monitoring a wireless power network is provided. The wireless power network comprises at least a first wireless power transmitter and at least a first wireless power receiver. The wireless power network monitoring device comprises: an energy transmitter interface configured to receive communication data indicative of an operating state of the first wireless power receiver from the first wireless power transmitter, the communication data being in a data transfer format of the wireless power network; an format conversion module configured to determine operating state information for the first wireless power receiver from the communication data by converting the communication data from the data transfer format of the wireless power network; and a graphical user interface configured to display the operating state information for the first wireless power receiver.

According to a fourth aspect of the present disclosure a wireless power network monitoring device for monitoring a wireless power network comprising a wireless power transmitter and at least a first wireless power receiver is provided. The wireless power network monitoring device comprises: an energy emitter interface configured to receive communication data indicative of an operating state of the first wireless power receiver from the wireless power transmitter, the communication data being in a data transfer format of the wireless power network; a format conversion module configured to determine operating state information for the first wireless power receiver from the communication data by converting the communication data from the data transfer format of the wireless power network; a processing module configured to process the operating state information for the first wireless power receiver to identify an abnormality; and a graphical user interface configured to generate an alert in response to identifying the abnormality.

According to a yet further aspect of the present invention, there is provided a computer-readable medium. The computer-readable medium has stored thereon program instructions for causing at least one processor to perform operations of a method disclosed above.

### BRIEF DESCRIPTION OF THE DRAWINGS

In the following, embodiments of the present invention will be described as non-limiting examples with reference to the accompanying drawings in which:

FIG. 1 shows a wireless power transmission network and a wireless power network monitoring device according to an embodiment of the present invention;

FIG. 2 is a block diagram showing a wireless power network monitoring device according to an embodiment of the present invention;

FIG. 3 is a flowchart showing a wireless power network monitoring method according to an embodiment of the present invention;

FIG. 4 shows a graphical user interface displaying a primary tab overview according to an embodiment of the present invention;

FIG. 5 shows a graphical user interface displaying a secondary tab for a sensor device according to an embodiment of the present invention;

FIG. 6 shows a graphical user interface displaying a secondary tab for a handheld electronic device according to an embodiment of the present invention;

FIG. 7 is a flowchart showing a wireless power network monitoring method according to an embodiment of the present invention; and

FIG. 8 shows a graphical user interface displaying a wireless power network selection tab according to an embodiment of the present invention

### DETAILED DESCRIPTION

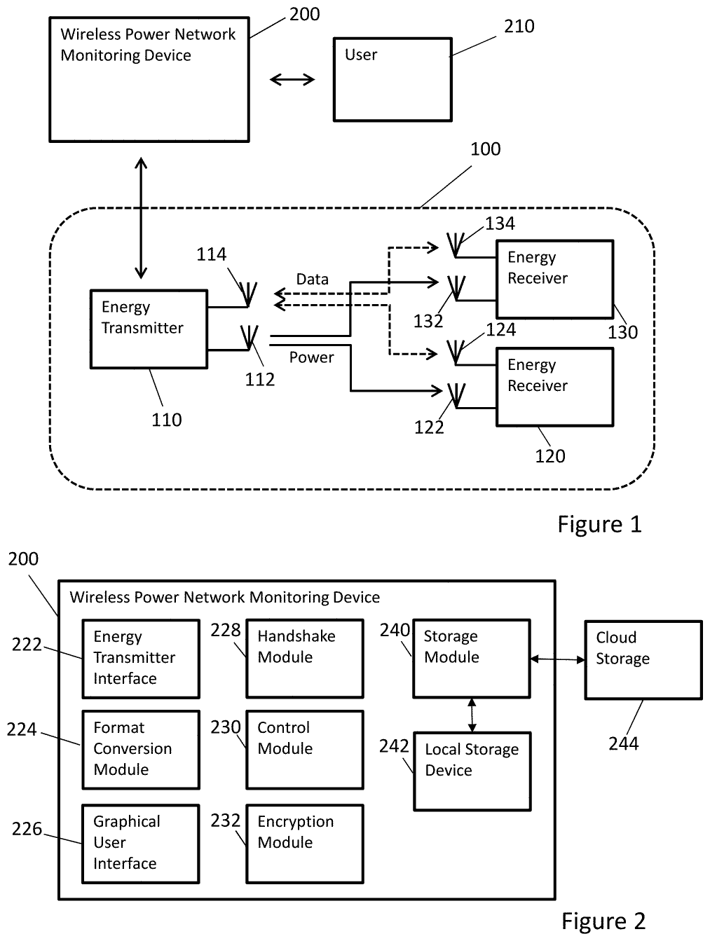

FIG. 1 is a block diagram showing a wireless power network and a wireless power network monitoring device according to an embodiment of the present invention. The wireless power network 100 comprises an energy transmitter 110, a first energy receiver 120 and a second energy receiver 130. The first energy receiver 120 and the second energy receiver 130 are wirelessly powered electronic devices such as Internet-of-Things (IoT) sensors, smartphones, computer peripherals, household appliances, and smart lights. The energy transmitter 110 has power transmission antenna 112 and a data communication antenna 114. The power transmission antenna 112 may be a single antenna or an array of antennas which are configurable to transmit power to the first energy receiver 120 and the second energy receiver 130. The power transmission may be at a frequency or a range of frequencies such as conventional RF bands including 433 MHz, 915 MHz, 2.4 GHz, 5.8 GHz, or millimeter-wave bands including 26, 28, 38, and 60 GHz. The power transmission may be over a combination of multiple frequency bands. The first energy receiver 120 has a power reception antenna 122 and a data communication antenna 124. Similarly, the second energy receiver 130 has a power reception antenna 132 and a data communication antenna 134. The data communication antennas of the energy transmitter 110, the first energy receiver 120 and the second energy receiver 130 allow communication over a wireless communication protocol such as a Bluetooth standard, alternatively, the communication may be according to the ZigBee, LoRa, WiFi, or Narrowband IoT (NB-IoT) communication protocols.

In use, the energy transmitter 110 transmits wireless power to each of the first energy receiver 120 and the second energy receiver 130. This may involve the energy transmitter 110 controlling the power transmission antenna 112 to produce a directional beam of electromagnetic radiation directed towards the power reception antenna 122 of the first energy receiver 120 and/or the power reception antenna 132 of the second energy receiver 130. The first energy receiver 120 and the second energy receiver 130 transmit feedback information such as channel state information of wireless power transmission back to the energy transmitter 110 using the respective data communication antennas. Data communication exchanged between the energy transmitter 110, and the first energy receiver 120 and the second energy receiver 130 may include state of charge information of energy storage units such as batteries or supercapacitors of the first energy receiver 120 and the second energy receiver 130, indications of received wireless power transmission strength, the uplink/downlink data transfer rate of each energy receiver, its GPS coordinates, sensor measurements, etc.

The wireless power network monitoring device 200 is coupled to the energy transmitter 110 by a data connection and acquires information of the information of individual energy receivers via existing communication protocols established between the energy transmitter 110, the first energy receiver 120 and the second energy receiver 130. The wireless power network monitoring device 200 consolidates the gathered information and presents it to the user 210 in an intuitive manner via a graphical user interface (GUI) or dashboard which is displayed by the wireless power network monitoring device 200. The wireless power network monitoring device 200 may be configured to send warning messages to the user 210 about health and performance issues of the wireless power network 100. The user can review these warning messages and send certain commands to the energy transmitter 100 and the energy receivers via the wireless power network monitoring device 200 to address the existing performance issues. The user 210 can make use of the corrective actions suggested by wireless power network monitoring device 200 or can use other mechanisms/software/tools to make the decision.

The wireless power network monitoring device 200 is connected to the energy transmitter 110 of the wireless power network 100 by a data connection. This data connection may be a wired data connection such a universal serial bus (USB) connection or a Thunderbolt connection, alternatively the connection may be a wireless connection supported by a protocol such as Bluetooth Low Energy (BLE), ZigBee, WIFI, etc.

The wireless power network 100 shown in FIG. 1 comprises a single energy transmitter and two energy receivers. It will be understood that in practice a wireless power network can host multiple energy transmitters. In this case, the wireless power network can be divided into multiple sub-networks, such that each sub-network consists of a single energy transmitter. It will be appreciated that the wireless power network may comprise a different number of energy receivers, FIG. 1 shows two energy receivers for simplicity.

In FIG. 1, the wireless power network monitoring device 200 and the energy transmitter are shown as separate devices. However embodiments are envisaged in which the functionality of the wireless power network monitoring device 200 is incorporated into an energy transmitter of a wireless power network.

FIG. 2 is a block diagram showing a wireless power network monitoring device according to an embodiment of the present invention. The wireless power network monitoring device 200 shown in FIG. 2 corresponds to the wireless power network monitoring device 200 shown in FIG. 1. The blocks and modules of the wireless power network monitoring device 200 may be implemented as specifically programmed hardware components or as software running on a microprocessor device or as a combination of the two. The wireless power network monitoring device 200 may be implemented as a computer in which case the modules may be implemented as software modules which are executed by a processor or central processing unit (CPU), alternatively, the wireless power network monitoring device 200 may be implemented as a standalone microcontroller or field programmable gate array (FPGA).

The wireless power network monitoring device 200 comprises an energy transmitter interface 222. The energy transmitter interface 222 is a data communications interface which allows communication between the wireless network monitoring device 200 and the energy transmitter 110 of the wireless power network 100. In some embodiments, the energy transmitter interface is realized through an input/output (I/O) port of the wireless power network monitoring device 200 such as a USB or thunderbolt port. Alternatively, the energy transmitter interface is a wireless interface which allows communication over a wireless protocol such as Bluetooth Low Energy (BLE), ZigBee, WIFI, etc. Additionally, in a typical wireless power network, the energy transmitter and receivers are all equipped with wireless communication modules to exchange feedback with each other to achieve optimal performance. Such communication links enable the wireless power network monitoring device 200 to gather information and send commands over the wireless power network 100.

The wireless power network monitoring device 200 further comprises a format conversion module 224. The format conversion module 224 allows conversion between a data format of the energy transmitter 110, the first energy receiver 120, and the second energy receiver 130 and a data format used by the wireless power network monitoring device 200. The data format of the wireless network monitoring device 200 may be customizable, and additionally, firmware of the wireless power network monitoring device 200 may be upgraded to include additional data formats. Thus, the wireless power network monitoring device 200 is future-proof as it can easily support succeeding energy transmitter and receiver models.

The wireless power network monitoring device 200 further comprises a graphical user interface 226. The graphical user interface 226 facilitates display of consolidated data to the user 210. The data displayed may include the instantaneous and average power consumption of each energy receiver connected to the energy transmitter within the wireless power network 100, the state-of-charge (SoC) of its storage unit, e.g., battery or super-capacitor, and the wireless power signal strength. Other information that may be displayed by the graphical user interface 266 includes the uplink/downlink data transfer rate of each energy receiver, its GPS coordinates, sensor measurements, etc. In some embodiments the graphical user interface 226 displays information as a plurality of tabs. The graphical user interface 226 displays alerts or warnings to alert the user 210 of health and performance issues affecting the wireless power network 100. Additionally, the graphical user interface 226 may display a list of possible corrective actions to the user 210 to address the performance issues.

The wireless power network monitoring device 200 further comprises a handshake module 228. The handshake module 228 is configured to implement a handshake process when the wireless power network monitoring device 200 boots up. The handshaking process is carried out between the wireless power network monitoring device 200 and the energy transmitter 110. Through the handshaking process, the wireless power network monitoring device 200 will determine parameters such as the data format, operational status, and communication protocols required to establish the connection with the energy transmitter 110 and each individual energy receiver connected to it.

The wireless power network monitoring device 200 further comprises a control module 230. The control module 230 is operable to generate commands to control the energy transmitter 110 and the energy receivers forming the wireless power network 100. The commands may be generated in response to user interactions with the graphical user interface 226 or may be generated automatically according to user selected preferences.

The wireless power network monitoring device further comprises an encryption module 232 which deploys an encryption program to encrypt data received from the wireless power network 100 before the data is stored.

The wireless power network monitoring device further comprises a storage module 240. The storage module 240 is coupled to a local storage device 242 of the wireless power network monitoring device 200 and to cloud storage 244 via an internet connection. The storage module 240 is operable to store data received from the wireless power network 100 on the local storage device 242 and/or on the cloud storage. The graphical user interface 226 may provide the user 210 with options to select the storage location and also whether data is encrypted by the encryption module 232 prior to being stored.

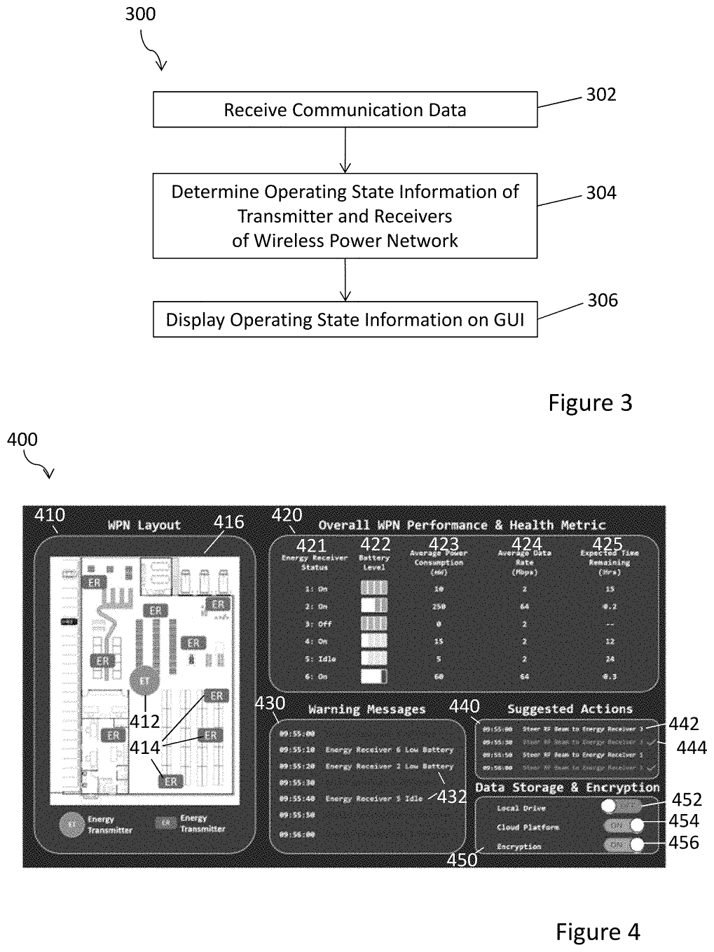

FIG. 3 is a flowchart showing a wireless power network monitoring method according to an embodiment of the present invention. The method 300 shown in FIG. 3 is implemented on the wireless power network monitoring device 200 shown in FIG. 2.

In step 302, the energy transmitter interface 222 of the wireless power network monitoring device 200 receives communication data from the energy transmitter 110 of the wireless power network 100. The communication data is in a data format of the wireless power network 100 and comprises an indication of an operating state of the energy transmitter 110 and an energy receiver, or both the first energy receiver 120 and the second energy receiver 130 of the wireless power network 100.

In step 304, the format conversion module 224 of the wireless power network monitoring device 200 determines operating state information of the energy transmitter 110 and the first energy receiver 120 and the second energy receiver 130 from the communication data. Step 304 may comprise converting the communication data from a format of the wireless power network 100.

In one embodiment, the communication data comprises an array of binary digits (1 or 0) which follows a predefined format. For example the array size may be set to 1024. Then, the first 16-bits show the receiver ID. The next 16 bits are the data of its first sensor, and so on. If there are no more sensor corresponding to a row then 0 will be sent. The format conversion module 224 saves the pre-defined format for each sensor to allow the operating state information to be determined from the communication data.

In step 306, the graphical user interface 226 of the wireless power network monitoring device 200 displays the operating state information.

The information displayed by the graphical user interface 226 of the wireless power network monitoring device 200 will now be described in more detail with reference to FIGS. 4, 5 and 6.

FIG. 4 shows a graphical user interface displaying a primary tab overview according to an embodiment of the present invention. The primary tab overview 400 comprises a wireless power network layout display 410. As shown in FIG. 4, the wireless power network layout display 410 shows locations of an energy receiver 412, and a plurality of energy receivers 414 overlaid over a plan 416 of the area of the wireless power network. The plan 416 and locations of the energy transmitter 412 and energy receivers 414 may be input into the wireless power network monitoring device 200. In some embodiments, the wireless power network monitoring device 200 determines the locations of the energy receivers 414 and/or the energy transmitter 412 from GPS information obtained in the communication data received from the wireless power network. The wireless power network monitoring device 200 may determine the location of the energy transmitter from either GPS data or from received signal strength indicator (RSSI) data.

The primary tab overview 400 comprises a wireless power network performance and health display 420. The wireless power network performance and health display 420 comprises indications of the status 412, battery level 422, average power consumption 423, average data rate 424 and expected time remaining 425 for each of the energy receivers connected to the wireless power network. The information shown in the wireless power network performance and health display 420 is determined from the communication data received by the wireless power network monitoring device 200 from the energy transmitter 110. As shown in FIG. 4, the battery level 422 is displayed as a number of bars of power (in this case out of five) remaining. Alternatively, the battery level may be displayed as a percentage of charge or other indication.

The primary tab overview 400 further comprises a warning messages display 430. The warning messages display 430 displays a plurality of warning messages 432. The warning messages 432 are generated by the graphical user interface 226 of the wireless power network monitoring device 200 when certain criteria are met. For example, the warning messages display 430 may display a warning message then the battery level of one of the energy receivers falls below a threshold or when one of the operating parameters of one of the energy receivers is outside a normal operating range. Thresholds and other conditions for generating the warning messages 432 may be user configurable on a global level or on a device level. For instance, if there is a sudden drop in the wireless power signal strength at a certain energy receiver, the graphical user interface 226 of the wireless power network monitoring device generates a warning message to the user about the possible interference between the energy transmitter and receiver. Another example is in the case that wireless power network monitoring device 200 detects an unauthorized energy receiver within the wireless power network, i.e., a device/sensor which is not included in the list of legitimate energy receivers defined by the user.

The primary tab overview 400 further comprises a suggested actions display 440. The suggested actions display 440 comprises indications of suggested actions 442 and user selectable accept buttons 444. The graphical user interface 226 generates the indications of suggested actions 442 which are displayed to the user to address performance issues. The wireless power network monitoring device 200 generates the indications of suggested actions 442 based on the instantaneous feedback received from the energy transmitter and receivers within the wireless power network, as well as the stored historical information such as the average harvested power at each energy receiver. As shown in FIG. 4, the user can accept each suggested action by clicking over the user selectable accept buttons 444 next to it; otherwise the suggested action will expire within a pre-defined window (e.g. 5 seconds). The user has the option to switch to an auto-accept mode. When a suggested action has been accepted by the user (or auto-accepted), the control module 230 of the wireless power network monitoring device 200 generates a control signal for the energy transmitter and/or energy receiver to perform the suggested action.

The primary tab overview 400 further comprises a data storage and encryption display 450. The data storage and encryption display 450 displays user controllable switches comprising a local drive switch 452, a cloud platform switch 454 and an encryption switch 456. The user can control whether data from the energy receivers such as sensor data and information on the wireless power network performance and health is stored on the local storage device 242 or the cloud storage 244. Further, the user can control whether the data is encrypted by the encryption module 232 of the wireless power network monitoring device 200 before being stored.

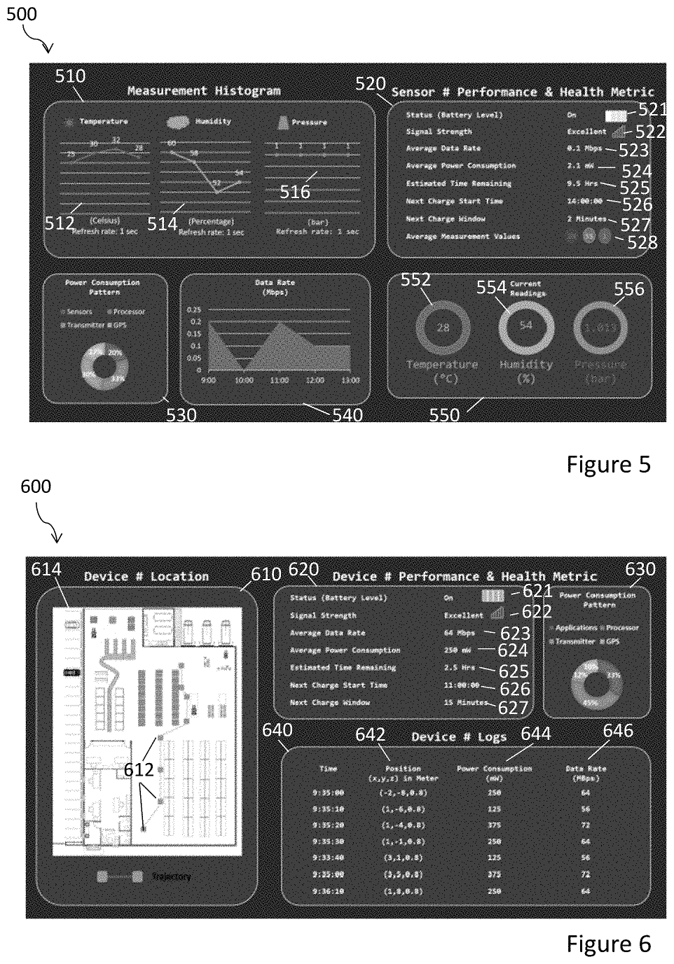

FIG. 5 shows a graphical user interface displaying a secondary tab for a sensor device according to an embodiment of the present invention. The secondary tab 500 comprises a measurement histogram display 510. In this example, the energy receiver is a sensor device comprising a temperature sensor, a humidity sensor and a pressure sensor. The measurement histogram display 510 comprises a temperature histogram 512, a humidity histogram 514 and a pressure histogram 516 which show respective sensor readings over a time period.

The secondary tab 500 further comprises a sensor performance and health metric display 520. The sensor performance and health metric display 520 comprises a status/battery level indicator 521, a signal strength indicator 522, an average data rate indication 523, an average power consumption indicator 524, an estimated time remaining indicator 525, an indication of the next charge start time 526, an indication of the next charge window 527, and indications of the average sensor measurements 528. The information displayed on the sensor performance and health metric display 520 is determined from the communication data received from the energy transmitter. The information may be determined from sensor data measured by sensors on the energy receiver, feedback data generated by the energy receiver, and scheduling data calculated by the energy transmitter.

The secondary tab 500 further comprises a power consumption pattern display 530. The power consumption pattern display 530 shows the power consumption of various devices or components of the energy receiver. In this example, the power consumption display shows the percentage power consumption by the sensors, the processor, the transmitter, and the GPS device located on the energy receiver. This information may be determined from feedback information transmitted by the energy receiver to the energy transmitter.

The second tab 500 further comprises a data rate display 540. The data rate display 540 shows a histogram of the data rate for data transfer between the energy receiver and the energy transmitter over time. This information may be determined from feedback information transmitted by the energy receiver to the energy transmitter.

The secondary tab 500 further comprises a current sensor readings display 550. The current sensor readings display 550 shows the current temperature reading 552, the current humidity reading 554 and the current pressure reading 556 measured by the sensors on the energy receiver.

FIG. 6 shows a graphical user interface displaying a secondary tab for a handheld electronic device according to an embodiment of the present invention. In this example, the energy receiver is a handheld device equipped with a global positioning system (GPS) location sensor and the secondary tab 600 is configured to display the movement of the handheld device.

As shown in FIG. 6, the secondary tab 600 comprises a device location display 610. The device location display 610 shows a trajectory 612 for the handheld device as a series of locations overlaid on a plan 614 of the area of the wireless power network. The locations making up the trajectory are determined from readings of the GPS location sensor of the handheld device.

The secondary tab 600 further comprises a device performance and health metric display 620. The device performance and health metric display 620 comprises a status/battery level indicator 621, a signal strength indicator 622, an average data rate indication 623, an average power consumption indicator 624, an estimated time remaining indicator 625, an indication of the next charge start time 626, and an indication of the next charge window 627. The information displayed on the device performance and health metric display 620 is determined from the communication data received from the energy transmitter. The information may be determined from feedback data generated by the energy receiver, and scheduling data calculated by the energy transmitter.

The secondary tab 600 further comprises a power consumption pattern display 630. The power consumption pattern display 630 shows the power consumption of various devices or components of the energy receiver. In this example, the power consumption display shows the percentage power consumption by the sensors, the processor, the transmitter, and the GPS device located on the energy receiver. This information may be determined from feedback information transmitted by the energy receiver to the energy transmitter.

The secondary tab 600 further comprises a device log display 640 which displays the device position 642, power consumption 644 and data rate 646 at various time points. This information is determined from the GPS sensor of the handheld device and feedback information transmitted by the handheld device to the energy transmitter.

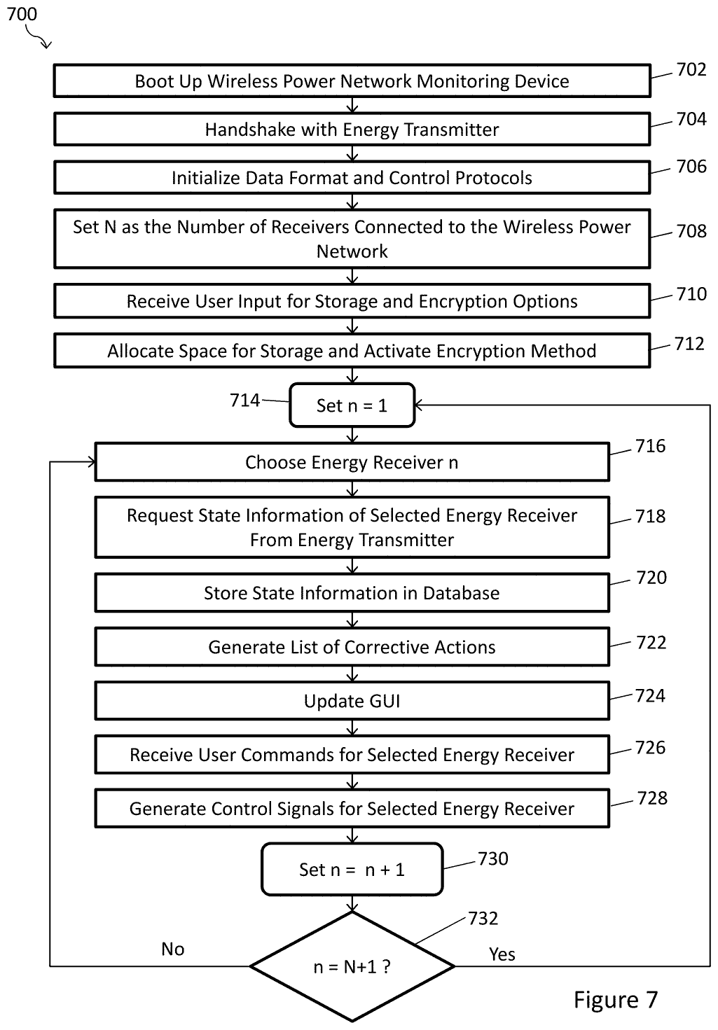

FIG. 7 is a flowchart showing a wireless power network monitoring method according to an embodiment of the present invention. The wireless power network monitoring method 700 shown in FIG. 7 may be implemented on a wireless power network monitoring device 200 shown in FIG. 2 using the graphical user interface tabs described above with reference to FIGS. 4 to 6.

In step 702, the wireless power network monitoring device 200 boots up. During step 702, the modules and interfaces of the wireless power network monitoring device 200 are initialized.

In step 704, the handshake module 228 of the wireless power network monitoring device 200 performs a handshake with the energy transmitter 110 of the wireless power network 100. During the handshake process, the handshake module 228 interrogates the energy transmitter 110 via the energy transmitter interface 222 and determines parameters such as the data format, operational status, and communication protocols required to establish the connection with the energy transmitter and each individual energy receiver connected to it.

In step 706, the format conversion module 224 and the control module 230 of the wireless power network monitoring device 200 are initialized with the data format and control protocols of the wireless power network 100 to allow the wireless power network monitoring device 200 to extract information from the energy emitter 110 and to generate control signals to control the energy emitter and the energy receivers of the wireless power network 100.

In step 708, the total number of receivers connected to the wireless power network is determined and set as N to allow the wireless power network monitoring device 200 to increment through each of the energy receivers of the wireless power network 100.

In step 710, the graphical user interface 226 of the wireless power network monitoring device 200 receives a user input indicating storage and encryption options selected by the user. The user uses local drive switch 452, the cloud platform switch 454 and the encryption switch 456 of the data storage and encryption display 450 to input a selection of a storage device and encryption method.

In step 712, the storage module 240 allocates space for storing data on either the local storage device 242 of the wireless power network monitoring device 200 or the cloud storage 244 and if selected, the encryption module 232 is activated.

In step 714, a counter n for energy receivers is set to 1.

In step 716, the n^{th} energy receiver is selected. In step 718, state information of the n^{th} energy receiver is requested from the energy transmitter 110 via the energy transmitter interface 222.

In step 718, the requested information is received and the format conversion module 224 converts the format of the received state information. In step 720, the received state information is stored in a database on either the local storage device 242 of the wireless power network monitoring device 200 or the cloud storage 244 depending on the user selection made in step 710.

In step 722, the graphical user interface 226 of the wireless power network monitoring device 200 generates a list of corrective actions. This list may be generated by comparing the state information with thresholds for example to determine if the battery level is below a threshold and in such a case the corrective action may be to steer the radiofrequency beam generated by the energy transmitter to the n^{th} energy receiver.

In step 724, the graphical user interface is updated with the corrective actions and the received state information. The information may be displayed as shown in FIG. 4 or one of FIGS. 5 and 6 depending on the type of energy receiver device.

In step 726, user commands are received though the graphical user interface 226 of the wireless power network monitoring device 200. The user may input the commands by selecting the select buttons 444 shown in FIG. 4.

In step 728, the control module 230 of the wireless network monitoring device 200 generates commands for the n^{th} energy receiver based on the user commands received in step 726. These commands are sent to the energy transmitter 110 though the energy transmitter interface 222. In response to the commands, the energy transmitter 110 either modifies its behavior or sends commands to the n^{th} energy receiver.

In step 730, the energy receiver counter n is incremented. In step 732 it is determined whether the incremented value of n is greater than N. If the incremented value of n is less than N, then the method moves to step 716 and the steps 716 to 728 are carried out for the next energy received. If the incremented value of n is N+1, then the method moves to step 714 and the value of n is reset to one and the steps 716 to 728 are repeated for the first energy receiver.

In the examples described above, the wireless power network monitoring device monitors and controls a single wireless power network. In practice, multiple wireless power networks can be connected to wireless power network monitoring device. In this case, while the wireless power network monitoring device boots up, it handshakes with each of the energy transmitters connected to the wireless power network monitoring device.

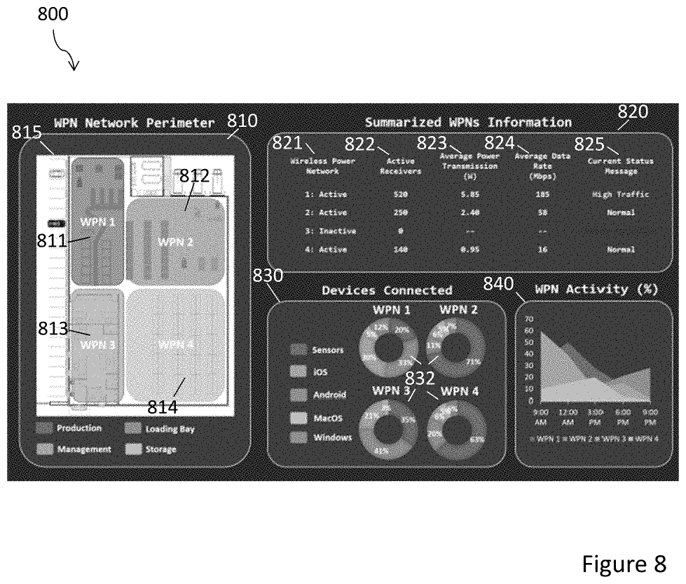

FIG. 8 shows a graphical user interface displaying a wireless power network selection tab according to an embodiment of the present invention. As shown in FIG. 8, the wireless power network selection tab 800 comprises a wireless power network perimeter display 810, a summarized wireless power network information display 820, a devices connected display 830 and a wireless power network activity display 840. In this example there are four energy transmitters connected to the wireless power network monitoring device and therefore there are considered to be four wireless power networks.

The wireless power network perimeter display 810 shows the area covered by each of the wireless power networks. As shown in FIG. 8, this area comprises a first wireless power network area 811, a second wireless power network area 812, a third wireless power network area 813 and a fourth wireless power network area 814. Each of the areas is overlaid on a plan 815 of the area of the four wireless power networks.

The summarized wireless power network information display 820 displays information about each of the four wireless power networks. As shown in FIG. 8, this information comprises an indication of the status 821 of each wireless power network, an indication of the number of active receivers 822 of each wireless power network, an indication of the average power transmission 823 of each wireless power network, an indication of the average data rate 824 of each wireless power network, and a current status message 825 for some of the wireless power networks. The current status messages 825 may comprise indications of the level of traffic on each of the wireless power networks.

The devices connected display 830 shows an indication 832 of the type of devices connected to each of the wireless power networks. The wireless power network activity display 840 shows the network activity of each of the networks as a percentage of the total capacity of each network.

The user may select one of the wireless networks from the wireless power network selection tab 800 shown in FIG. 8, upon selection of one of the wireless power networks, a primary tab overview 400 as shown in FIG. 4 is displayed and the user may then make a selection of one of the energy receivers in which case a secondary tab such as those shown in FIGS. 5 and 6 is displayed.

The graphical user interface of the wireless power network monitoring device is highly customizable. The user intervention level can be changed by modifying both the primary and secondary tabs e.g. the user may remove certain information from being displayed (by using the hide option), switching on/off the warning messages, creating new subclasses of warning messages, and defining automated actions to be performed for these warnings. In some embodiments, the graphical user interface is accessible on smartphones, tablets, and remote desktops connected to the Internet or to the local network which the computer running wireless power network monitoring device is connected to.

Whilst the foregoing description has described exemplary embodiments, it will be understood by those skilled in the art that many variations of the embodiments can be made within the scope and spirit of the present invention.

1. A method of monitoring a wireless power network, the wireless power network comprising at least a first wireless power transmitter and at least a first wireless power receiver, the method comprising:
receiving communication data indicative of an operating state of the first wireless power receiver from the first wireless power transmitter, the communication data being in a data transfer format of the wireless power network;
determining operating state information for the first wireless power receiver from the communication data by converting the communication data from the data transfer format of the wireless power network; and
displaying the operating state information for the first wireless power receiver in a graphical user interface.

2. A method according to claim 1, further comprising determining the data transfer format of the wireless power network during a handshaking process.

3. A method according to claim 1, further comprising determining information indicating a type or specification of the first wireless power receiver and customizing the graphical user interface according to the type or specification of the first wireless power transmitter.

4. A method according to claim 1, further comprising storing the operating state information for the first wireless power receiver.

5. (canceled)

6. A method according to claim 1, wherein the operating state of the first wireless power receiver comprises one or more of the following:
instantaneous power consumption of the first wireless power receiver;
average power consumption of the first wireless power receiver;
a state of charge of an energy storage device of the first wireless power receiver; and/or
a received wireless power signal strength at the first wireless power receiver.

7. A method of monitoring a wireless power network, the wireless power network comprising a wireless power transmitter and at least a first wireless power receiver, the method comprising:
receiving communication data indicative of an operating state of the first wireless power receiver from the wireless power transmitter, the communication data being in a data transfer format of the wireless power network;
determining operating state information for the first wireless power receiver from the communication data by converting the communication data from the data transfer format of the wireless power network; and
processing the operating state information for the first wireless power receiver to identify an abnormality; and
generating an alert in response to identifying the abnormality.

8. A method according to claim 7, wherein processing the operating state information to identify an abnormality comprises comparing the operating state information with a threshold or a target range of values.

9-10. (canceled)

11. A method according to claim 7, further comprising generating a control signal for the first wireless power receiver to adjust an operating parameter of the first wireless power receiver.

12. (canceled)

13. A method according to claim 7, further comprising displaying an indication of at least one possible corrective action and receiving a user input indicating a corrective action.

14-15. (canceled)

16. A wireless power network monitoring device for monitoring a wireless power network comprising at least a first wireless power transmitter and at least a first wireless power receiver, the wireless power network monitoring device comprising:
an energy transmitter interface configured to receive communication data indicative of an operating state of the first wireless power receiver from the first wireless power transmitter, the communication data being in a data transfer format of the wireless power network;
a format conversion module configured to determine operating state information for the first wireless power receiver from the communication data by converting the communication data from the data transfer format of the wireless power network; and
a graphical user interface configured to display the operating state information for the first wireless power receiver.

17. A wireless power network monitoring device according to claim 16, further comprising a handshake module configured to determine the data transfer format of the wireless power network during a handshaking process.

18. A wireless power network monitoring device according to claim 16, further comprising a determining information indicating a type or specification of the first wireless power receiver and customizing the graphical user interface according to the type or specification of the first wireless power receiver.

19. A wireless power network monitoring device according to claim 16, further comprising a storage module operable to store the operating state information for the first wireless power receiver.

20. (canceled)

21. A wireless power network monitoring device according to claim 16, wherein the operating state of the first wireless power receiver comprises one or more of the following:
instantaneous power consumption of the first wireless power receiver;
average power consumption of the first wireless power receiver;
a state of charge of an energy storage device of the first wireless power receiver; and/or
a received wireless power signal strength at the first wireless power receiver.

22. A wireless power network monitoring device for monitoring a wireless power network comprising a wireless power transmitter and at least a first wireless power receiver, wireless power network monitoring device comprising:
an energy emitter interface configured to receive communication data indicative of an operating state of the first wireless power receiver from the wireless power transmitter, the communication data being in a data transfer format of the wireless power network;
a format conversion module configured to determine operating state information for the first wireless power receiver from the communication data by converting the communication data from the data transfer format of the wireless power network;
a processing module configured to process the operating state information for the first wireless power receiver to identify an abnormality; and
a graphical user interface configured to generate an alert in response to identifying the abnormality.

23. A wireless power network monitoring device according to claim 22, wherein processing the operating state information to identify an abnormality comprises comparing the operating state information with a threshold or a target range of values.

24. (canceled)

25. A wireless power network monitoring device according to claim 22, further comprising a storage module configured to store the operating state information for the first wireless power receiver as historical operating state information.

26. A wireless power network monitoring device according to claim 22, further comprising a control module configured to generate a control signal for the first wireless power receiver to adjust an operating parameter of the first wireless power receiver.

27. (canceled)

28. A wireless power network monitoring device according to claim 22, wherein the graphical user interface is further configured to display an indication of at least one possible corrective action and to receive a user input indicating a corrective action.

29-30. (canceled)

31. A computer readable earner medium carrying processor executable instructions which when executed on a processor cause the processor to carry out a method according to claim 1.
